(19) United States
(12) Patent Application Publication
(10) Pub. No.: US 2012/0084503 A1
(43) Pub. Date: Apr. 5, 2012

(54) DISK CONTROL APPARATUS, DISK CONTROL METHOD, AND STORAGE MEDIUM STORING DISK CONTROL PROGRAM

(75) Inventor: Yuichi HAGIWARA, Tokyo (JP)

(73) Assignee: CANON KABUSHIKI KAISHA, Tokyo (JP)

(21) Appl. No.: 13/250,020

(22) Filed: Sep. 30, 2011

(30) Foreign Application Priority Data
Oct. 1, 2010 (JP) 2010-223807

(51) Int. Cl. G06F 12/08

(52) U.S. Cl. 711/112; 711/E12.019

(57) ABSTRACT

A disk control apparatus that is capable of performing a reliable mirroring control for both of an SSD and an HDD. The disk control apparatus that performs a mirroring control to the SSD and the HDD. An acquisition unit acquires the data rewriting number in the SSD. A derivation unit derives a data retention period of the SSD from the data rewriting number acquired. A comparison unit compares a predetermined threshold value with an increment between the data rewriting number acquired at a predetermined timing and the data rewriting number acquired after a retention period, which is derived from the data rewriting number at the predetermined timing, elapses. A setting unit sets so as to read data from the SSD by default and to read data from the HDD when the comparison unit determines that the increment is less than the threshold value.

### BACKGROUND OF THE INVENTION

1. Field of the Invention

The present invention relates to a disk control apparatus, a disk control method, and storage medium storing a disk control program. Particularly, the present invention relates to a technique performing a mirroring control.

2. Description of the Related Art

A general computer stores data used for a process in an external storage like a hard disk (referred to as “HDD”) and uses a redundant disk array like RAID (Redundant Array of Independent Inexpensive Disks) in order to protect the stored data. In the RAID technology, RAID of level 1 (RAID 1) that is a mirroring configuration for storing the same data in a plurality of disc drives, etc. are defined.

A disk control apparatus that achieves the RAID 1 has a data restoration function called a rebuilding function. The rebuilding function enables to restore data stored in a broken HDD to an exchange HDD.

An HDD reads and writes data by moving a magnetic head on a platter that spins rapidly. Therefore, an HDD has problems of “it is vulnerable to a shock or vibration”, “power consumption is large”, “starting is slow”, etc., and replacement to an SSD (Solid State Drive) that uses a semiconductor memory is advanced as substitution of an HDD in recent years.

Japanese Laid-Open Patent Publication (Kokai) No. 2005-250644 (JP 2005-250644A) discloses an example of the above-mentioned disk control apparatus that performs the mirroring using disks by turns in order to prolong the life of disks. The disk control apparatus uses a disk array device having three disks, performs the mirroring in a pair of disks, and changes the pair periodically.

However, since the disk control apparatus of JP 2005-250644A comprises disks of the same type, when the disk array is constituted by HDDs, power consumption becomes large and starting becomes slow. Even when the disk array is constituted by SSDs in order to reduce power consumption and to accelerate starting, an SSD has a problem that “the rewritable number” and “data retention period” are limited. Therefore, when the RAID 1, which writes the same data in drives of a disk array, is constituted by SSDs, the rewriting numbers or the data retention periods of SSDs might reach the limit simultaneously, which may cause a serious problem of data lost despite the mirroring.

### SUMMARY OF THE INVENTION

The present invention provides a disk control apparatus, a disk control method, and a disk control program which are capable of performing a reliable mirroring control for both of a storage unit that is constituted by semiconductor memories and a storage unit that is constituted by magnetic disks.

Accordingly, a first aspect of the present invention provides a disk control apparatus that performs a mirroring control to a first storage unit that is constituted by a semiconductor memory and a second storage unit that is constituted by a magnetic disk, comprising an acquisition unit configured to acquire the data rewriting number in the first storage unit, a derivation unit configured to derive a data retention period of the first storage unit from the data rewriting number acquired by the acquisition unit, a comparison unit configured to compare a predetermined threshold value with an increment between the data rewriting number acquired by the acquisition unit at a predetermined timing and the data rewriting number acquired by the acquisition unit after a retention period, which is derived from the data rewriting number at the predetermined timing, elapses, and a setting unit configured to set so as to read data from the first storage unit by default and to read data from the second storage unit when the comparison unit determines that the increment is less than the threshold value.

Accordingly, a second aspect of the present invention provides a disk control method for a disk control apparatus that performs a mirroring control to a first storage unit that is constituted by a semiconductor memory and a second storage unit that is constituted by a magnetic disk, comprising a first setting step of setting so as to read data from the first storage unit by default, a first acquisition step of acquiring the data rewriting number in the first storage unit, a derivation step of deriving a data retention period of the first storage unit from the data rewriting number acquired in the first acquisition step, a second acquisition step of acquiring the data rewriting number in the first storage unit after the data retention period derived in the derivation step elapses, a comparison step of comparing a predetermined threshold value with an increment between the data rewriting number acquired in the first acquisition step and the data rewriting number acquired in the second acquisition step, and a second setting step of setting so as to read data from the second storage unit when it is determined that the increment is less than the threshold value in the comparison step.

Accordingly, a third aspect of the present invention provides a non-transitory computer-readable storage medium storing a disk control program causing a computer to execute a disk control method for a disk control apparatus that performs a mirroring control to a first storage unit that is constituted by a semiconductor memory and a second storage unit that is constituted by a magnetic disk and is set so as to read data from the first storage unit in advance, the disk control method comprising a first setting step of setting so as to read data from the first storage unit by default, a first acquisition step of acquiring the data rewriting number in the first storage unit, a derivation step of deriving a data retention period of the first storage unit from the data rewriting number acquired in the first acquisition step, a second acquisition step of acquiring the data rewriting number in the first storage unit after the data retention period derived in the derivation step elapses, a comparison step of comparing a predetermined threshold value with an increment between the data rewriting number acquired in the first acquisition step and the data rewriting number acquired in the second acquisition step, and a second setting step of setting so as to read data from the second storage unit when it is determined that the increment is less than the threshold value in the comparison step.

According to the present invention, the reliable mirroring control can be performed for both of the storage unit that is constituted by the semiconductor memories and the storage unit that is constituted by the magnetic disks.

Further features of the present invention will become apparent from the following description of exemplary embodiments with reference to the attached drawings.

### BRIEF DESCRIPTION OF THE DRAWINGS

FIG. 1 is a block diagram schematically showing a configuration of a disk control apparatus according to an embodiment of the present invention.

FIG. 2 is a view showing a retention period table that the disk control apparatus in FIG. 1 uses at the time of a mirroring control.

FIG. 3 is a flowchart showing a procedure of a mirroring control process executed by a CPU in FIG. 1.

### DESCRIPTION OF THE EMBODIMENTS

Hereafter, embodiments according to the present invention will be described in detail with reference to the drawings.

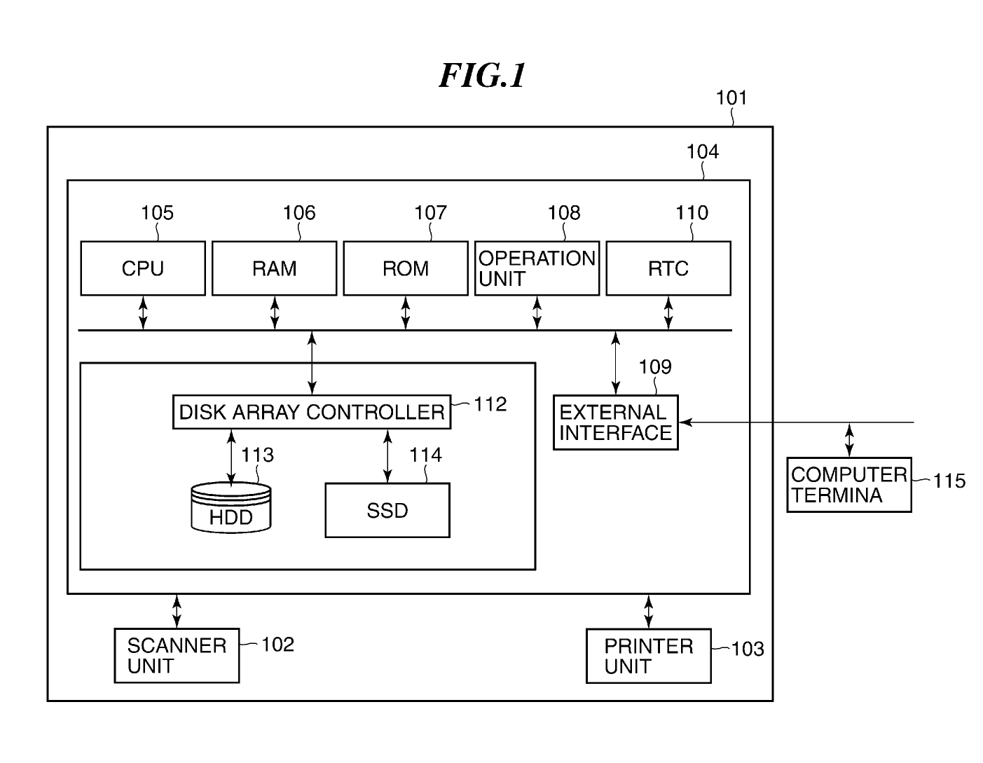

FIG. 1 is a block diagram schematically showing a configuration of an image forming apparatus that is provided with a disk control apparatus according to an embodiment of the present invention.

In FIG. 1, the image forming apparatus 101 has a controller 104 built-in as the disk control apparatus concerning the embodiment of the invention. This embodiment is applicable to all the apparatuses such as a personal computer, a server computer, various household appliances that can connect to the disk control apparatus, besides the image forming apparatus.

The image forming apparatus 101 in FIG. 1 is provided with the controller 104, a scanner unit 102, and a printer unit 103, and is connected with a computer terminal 115 via a network. The controller 104 is connected with the scanner unit 102 and the printer unit 103.

the scanner unit 102 is an image input device and the printer unit 103 is an image output device. They can be constituted by known art.

The controller 104 controls the entire image forming apparatus 101, and has a CPU 105, a RAM 106, a ROM 107, an operation unit 108, an RTC 110, an external interface 109, and the disk control apparatus 111, which are mutually connected via a bus.

The CPU 201 controls the entire image forming apparatus 101. The RAM 106 is a volatile memory that temporarily stores a program, data, etc., which are needed for the CPU 105 to operate. The ROM 107 is a nonvolatile memory that stores a boot program etc. for the image forming apparatus 101. The operation unit 108 is a user interface (UI) for operating the image forming apparatus 101 or displaying a state of the image forming apparatus 101. The RTC 110 is a real-time clock device that clocks current time, and continues operating by battery backups even while the power of the image forming apparatus 101 is off. The external interface 109 is used to connect with the computer terminal 115 as external equipment via LAN etc.

The disk control apparatus 111 is provided with a disk array controller 112 connected to the bus, an SSD (Solid State Drive) 114, and an HDD (Hard Disk Drive) 113. The SSD 114 and the HDD 113 are connected to the disk array controller 112, respectively. In the following description, the combination of the HDD 113 and the SSD 114 is simply referred to as a drive.

The SSD 114 is constituted by semiconductor memories and the HDD 113 is constituted by magnetic disks. The disk array controller 112 performs a mirroring control to the SSD 114 and the HDD 113. The CPU 105 sets beforehand so as to read data from the SSD 114.

The HDD 113 and the SSD 114 store various kinds of data including programs for the image forming apparatus 101, image data, an operating system, etc.

The disk array controller 112 stores writing data transferred from the CPU 105 into the HDD 133 and stores the same data also into the SSD 114. Accordingly, the data structures of the HDD 113 and the SSD 114 become identical.

The CPU 105 reads data only from a predetermined drive. Hereafter, the predetermined drive from which data is read is referred to as a primary drive, and the other drive is referred to as a secondary drive.

Usually, the SSD 114 is constituted as the primary drive and the HDD 113 is constituted as the secondary drive. It is common to perform a consistency check periodically in redundant RAID constitution. The consistency check compares data of both the drives that perform the mirroring, and adjusts the data consistency by overwriting the data in the secondary drive with the data in the primary drive when inconsistency of the data is detected.

Next, the S.M.A.R.T. (Self-Monitoring Analysis and Reporting Technology) function will be described. The S.M.A.R.T. function is a self-checking function with which an SSD and an HDD are provided, records various kinds of information about the SSD and the HDD including the number of times of switching-on, the number of bad sectors, etc., and can notify of the possibility of failure beforehand. The recording items of the S.M.A.R.T. for the SSD are different from that for the HDD. An item of “Max Erase Count” is recorded only by the SSD.

The “Max Erase Count” expresses the number of erasing of the block with the maximum number of erasing in all the blocks of the SSD. A block in an SSD is a unit to erase data in a flash memory, and the size of the unit is larger than the size of a page that is a unit to read and write data. Then, when data is rewritten, it is necessary to erase data per the block and then to write per a page. Therefore, the number of erasing of the block is identical to a rewriting number.

A wear leveling function of an SSD controller (not shown), which controls the SSD, controls the rewriting numbers of blocks in the SSD so that the rewriting numbers of all the blocks are almost equalized. Therefore, it is designed so that the number of erasing of a specific block may not increase extremely.

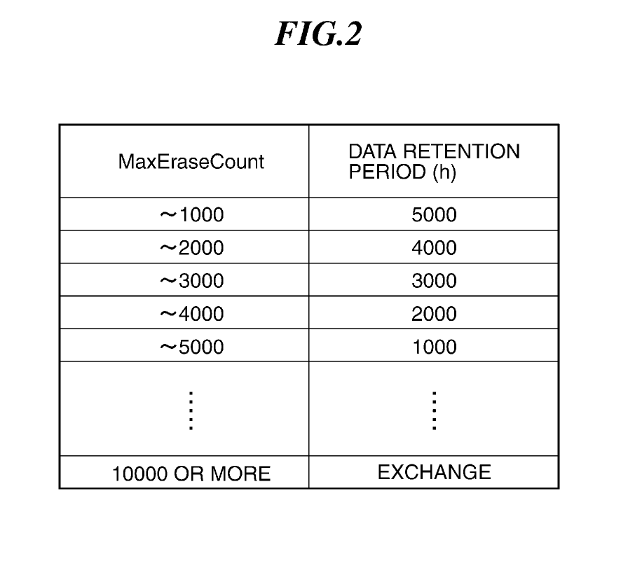

FIG. 2 is a view showing a retention period table (retention period information) that the disk control apparatus 111 in FIG. 1 uses at the time of the mirroring control.

In the retention period table in FIG. 2, the “Max Erase Count” that is the data rewriting number in the SSD 114 is correlated with a “data retention period” that define a retention period corresponding to the rewriting number.

For example, the retention period table shows that the written data will be held in 5000 hours from the time of writing data when the Max Erase Count is 1000 or less. The retention period table shows that the SSD 114 should be exchanged when the Max Erase Count is 10000 or more.

This retention period table is beforehand built into a mirroring control program of the disk control apparatus 111.

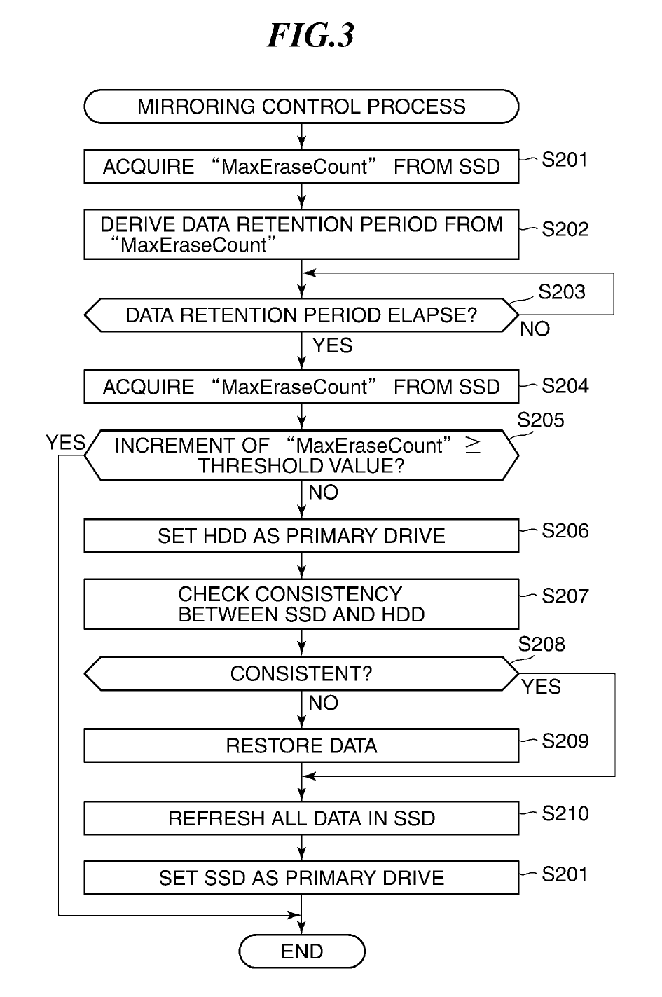

FIG. 3 is a flowchart showing a procedure of a mirroring control process executed by the CPU 105 in FIG. 1.

In FIG. 3, the CPU 105 acquires the Max Erase Count (the rewriting number) from the SSD 114 (step S201), derives the data retention period in the SSD 114 from the acquired rewriting number using the above-mentioned retention period table (step S202), and determines whether the data retention period elapsed (step S203). When the data retention period elapsed (YES in the step S203), the CPU 105 acquires the Max Erase Count from the SSD 114 again (step S204), finds the increment by comparing the Max Erase Count acquired in the step S201 with the Max Erase Count acquired in the step S204, and determines whether the increment is equal to or larger than a predetermined threshold value (step S205).

When the increment of the Max Erase Count is equal to or larger than the threshold value (YES in the step S205), the CPU 105 determines that the data in each block has been rewritten before the data retention period elapses, and finishes the process immediately.

It should be noted that the threshold value is set as about 2 through 10 in consideration of the wear leveling. Although this process determines whether data in each block was rewritten using the Max Erase Count, an Average Erase Count that expresses an average number of erase count or the combination of them may be used to determine.

On the other hand, when the increment of the Max Erase Count is smaller than the threshold value (NO in the step S205), since this means that data in the SSD 114 has not been rewritten before the data retention period elapses, the data in the SSD 114 may have disappeared and the data cannot be guaranteed. Therefore, the CPU 105 replaces the settings of the primary drive and the secondary drive, and sets the HDD 113 as the primary drive (step S206).

Next, the CPU 105 determines whether the data stored in the HDD 133 is consistent with the data stored in the SSD 114 in order to check the unguaranteed data in the SSD 114 (step S207). When the consistency of the data is confirmed (YES in the step S208), the CPU 105 proceeds with the process to step S210. When the inconsistency of the data is confirmed, the CPU 105 restores the data in the SSD 114 by overwriting the SSD 114 with the data stored in the HDD 113, and proceeds with the process to step S210.

In the step S210, the CPU 105 refreshes all the blocks of the SSD 114. The refreshment means to rewrite the same data to all the blocks after erasing the data of the blocks. The data retention period of the SSD 114 is cleared by refreshing.

After refreshing, the CPU 105 sets the SSD 114 as the primary drive and the HDD 113 as the secondary drive (step S211), and finishes the process.

When the Max Erase Count acquired in the step S201 has reached the upper limit defined in the retention period table, the fact may be displayed on the operation unit 108 in the step S202 to encourage a user to exchange the SSD 114.

According to the process in FIG. 3, the data rewriting number in the SSD 114 is acquired (the step S204) after the data retention period of the SSD 114 that is derived from the data rewriting number in the SSD 114 has elapsed . Then, when the increment of the rewriting number does not larger than the predetermined threshold value, the CPU 105 determines that the reliability of the data in the SSD 114 lowers, and sets to read data from the reliable HDD 113 (step S206). This achieves the reliable mirroring control.

Before the HDD 113 is set as the primary drive in the step S206, and after the SSD 114 is set as the primary drive in the step S211, the performance about reading data can be improved because the data reading speed from the SSD 144 is generally higher than that from the HDD 113.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-223807, filed on Oct. 1, 2010, which is hereby incorporated by reference herein in its entirety.

What is claimed is:

1. A disk control apparatus that performs a mirroring control to a first storage unit that is constituted by a semiconductor memory and a second storage unit that is constituted by a magnetic disk, comprising:
an acquisition unit configured to acquire the data rewriting number in the first storage unit;
a derivation unit configured to derive a data retention period of the first storage unit from the data rewriting number acquired by said acquisition unit;
a comparison unit configured to compare a predetermined threshold value with an increment between the data rewriting number acquired by said acquisition unit at a predetermined timing and the data rewriting number acquired by said acquisition unit after a retention period, which is derived from the data rewriting number at the predetermined timing, elapses; and
a setting unit configured to set so as to read data from the first storage unit by default and to read data from the second storage unit when said comparison unit determines that the increment is less than the threshold value.

2. The disk control apparatus according to claim 1, further comprising:
a determination unit configured to determine whether the data stored in the first storage unit is consistent with the data stored in the second storage unit when said setting unit sets so as to read data from the second storage unit;
a restoration unit configured to restore data by overwriting the data stored in the second storage unit with the data stored in the first storage unit when the determination unit determines to be inconsistent; and
a refreshment unit configured to refresh the first storage unit when said discrimination unit determined to be consistent or when said restoration unit restored the data,
wherein said setting unit sets so as to read data from the first storage unit when said refreshment unit refreshed the first storage unit.

3. The disk control apparatus according to claim 1, wherein the first storage unit has an S.M.A.R.T. function, and said acquisition unit acquires either one of Max Erase Count and Average Erase Count, which are stored in the first storage unit, by the S.M.A.R.T. function as the data rewriting number.

4. The disk control apparatus according to claim 1, wherein said derivation unit derives the data retention period using retention period information that correlates the data rewriting number in the first storage unit with the data retention period.

5. A disk control method for a disk control apparatus that performs a mirroring control to a first storage unit that is constituted by a semiconductor memory and a second storage unit that is constituted by a magnetic disk, comprising:
a first setting step of setting so as to read data from the first storage unit by default;
a first acquisition step of acquiring the data rewriting number in the first storage unit;
a derivation step of deriving a data retention period of the first storage unit from the data rewriting number acquired in said first acquisition step;
a second acquisition step of acquiring the data rewriting number in the first storage unit after the data retention period derived in said derivation step elapses;
a comparison step of comparing a predetermined threshold value with an increment between the data rewriting number acquired in said first acquisition step and the data rewriting number acquired in said second acquisition step; and
a second setting step of setting so as to read data from the second storage unit when it is determined that the increment is less than the threshold value in said comparison step.

6. A non-transitory computer-readable storage medium storing a disk control program causing a computer to execute a disk control method for a disk control apparatus that performs a mirroring control to a first storage unit that is constituted by a semiconductor memory and a second storage unit that is constituted by a magnetic disk and is set so as to read data from the first storage unit in advance, the disk control method comprising:
a first setting step of setting so as to read data from the first storage unit by default;
a first acquisition step of acquiring the data rewriting number in the first storage unit;
a derivation step of deriving a data retention period of the first storage unit from the data rewriting number acquired in said first acquisition step;
a second acquisition step of acquiring the data rewriting number in the first storage unit after the data retention period derived in said derivation step elapses;
a comparison step of comparing a predetermined threshold value with an increment between the data rewriting number acquired in said first acquisition step and the data rewriting number acquired in said second acquisition step; and
a second setting step of setting so as to read data from the second storage unit when it is determined that the increment is less than the threshold value in said comparison step.
